(19) United States
(12) Patent Application Publication
(10) Pub. No.: US 2007/0063834 A1
(43) Pub. Date: Mar. 22, 2007

(54) Method and apparatus to reduce loss or damage to remote control devices

(75) Inventors: Stephen O. Bozzone, Lauderhill, FL (US); Alan R. Beatty, Plantation, FL (US); Sybren D. Smith, Plantation, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/203,780

(22) Filed: Aug. 15, 2005

(51) Int. Cl. G08B 1/08; H04Q 7/00

(52) U.S. Cl. 340/539.1

(57) ABSTRACT

A remote controlling device (12) having a first transceiver (9) and first processor (16) for controlling a remote controlled apparatus (18) having a second wireless transceiver (20) and a second processor (24). The processors can be programmed to measure a signal quality level of signals transmitted by the wireless transceiver(s) to redirect the remote controlled apparatus if the signal quality level falls below a predetermined threshold. The processor(s) can be further programmed to transmit control signals to redirect (56) the remote controlled apparatus toward the remote controlling device or to safely stop the remote controlled apparatus or to cause the remote controlled apparatus to meander so long as the signal quality level stays above the predetermined threshold.

### FIELD OF THE INVENTION

This invention relates generally to remote controlled systems, and more particularly to a method a system to prevent loss or damage to remote controlled (RC) devices such as RC toys.

### BACKGROUND OF THE INVENTION

Remote controlled (RC) apparatus and particularly remote controlled toys have traditionally used one-way communications to control the operation of the RC apparatus. When an RC toy goes out of range of a remote controlling device, the RC toy is out of control of the user. Such a scenario can easily cause the loss of the toy or damage. Furthermore, the user typically needs to physically retrieve the remote controlled toy once it stops at some remote distance or at an inconvenient location to the user (e.g., in the middle of a lake or highway).

### SUMMARY OF THE INVENTION

Embodiments in accordance with the present invention can prevent or reduce damage when Radio Controlled (R/C) toys such as boats, cars, airplanes, or robots start to get out of range. When an R/C toy is out of range it is out of control of the user. Embodiments herein can alert the user when the toy is close to being out of range. If the user continues to operate the toy to allow the toy to go further out of range, the toy can enter an autonomous mode to prevent it from going completely out of range. This has specific utility for R/C toys such as boats and airplanes, but can certainly be applied to other remotely controlled devices. If a boat is out of range from the user, the user has to go retrieve the toy from the water. Likewise, for a toy airplane, if the plane is out of range it can crash, fly out of control into a tree, onto a roof or into a building. Since R/C toys currently do not use digital two-way communication protocols, there are no methods for preventing such loss or damage.

In a first embodiment of the present invention a remote controlling device can include a wireless transceiver for controlling a remote controlled apparatus having a wireless transceiver and a processor coupled to the wireless transceiver of the remote controlling device. The remote controlling device can be a two-way radio, a cellular phone, a cordless home phone, a computer with wireless capability, or a smart phone for example and the remote controlled device can be a remote controlled car, boat, aircraft, or robot as examples. Of course, the remote controlling device can also be a conventional remote controlling device having one or more joysticks, but further having the appropriate software as contemplated herein. The wireless transceiver in the remote controlling device and in the remote controlled apparatus can use the IEEE 802.15.4 Standard for communication. Note, the processor can be an 8 bit microcontroller or other processing device that can be programmed to measure a signal quality level of signals transmitted by the wireless transceiver of the remote controlled apparatus and to transmit control signals to redirect the remote controlled apparatus if the signal quality level falls below a predetermined threshold. The processor can measure signal strength indicator measurements or bit error rate among other signal quality measurements. The predetermined threshold can also be programmable by the user. The remote controlling device can also include a user alert that warns a user when the signal quality level falls below the predetermined threshold. The processor can be further programmed to transmit control signals to redirect the remote controlled apparatus toward the remote controlling device or to safely stop the remote controlled apparatus or to cause the remote controlled apparatus to meander so long as the signal quality level stays above the predetermined threshold. In another aspect, the wireless transceiver in the remote controlled apparatus can also measure a signal quality level and can transmit a warning signal to the remote controlling device when the signal quality level measured at the remote controlled apparatus falls below a predetermined threshold.

In a second embodiment of the present invention, a system for controlling a remote controlled apparatus can include a first wireless transceiver in a remote controlling device for controlling the remote controlled apparatus, a second wireless transceiver in the remote controlled apparatus, and a processor coupled to the second wireless transceiver of the remote controlling device. The processor can be programmed to measure a signal quality level of signals transmitted by the first wireless transceiver and to redirect the remote controlled apparatus if the signal quality level falls below a predetermined threshold. As noted above the remote controlled apparatus can be a remote controlled car, a remote controlled boat, a remote controlled aircraft, or a remote controlled robot and the remote controlling device can be a two-way radio, a cellular phone, a cordless home phone, a computer with wireless capability, or a smart phone among other communication devices. As noted above, the remote controlling device can also be an R/C controller having one or more joysticks or other directional controllers. The first and second wireless transceivers can use the IEEE 802.15.4 Standard. The remote controlling device can further include a user alert that warns a user when the signal quality level falls below the predetermined threshold. In one aspect, the second wireless transceiver can transmit a warning signal to the remote controlling device when the signal quality level measured at the remote controlled apparatus falls below a predetermined threshold.

The system can further include a processor coupled to the first wireless transceiver. The processor coupled to the first wireless transceiver can be programmed to measure a signal quality level of signals transmitted by the second wireless transceiver (to the first wireless transceiver) and can transmit signals to redirect the remote controlled apparatus when a signal quality level of the signals transmitted by the second wireless transceiver falls below a predetermined threshold. The predetermined threshold can be a programmable setting. The processor coupled to the first wireless transceiver or the processor coupled to the second wireless transceiver can be programmed to measure received signal strength indicator measurements or bit error rate. The processor in the remote controlled apparatus or a processor in the remote controlling device can further be programmed to redirect the remote controlled apparatus toward the remote controlling device or to safely stop the remote controlled apparatus or to cause the remote controlled apparatus to meander so long as the signal quality level stays above the predetermined threshold.

In a third embodiment of the present invention, a method of controlling a remote controlled apparatus can include the steps of measuring a signal quality level of at least one signal between the remote controlled apparatus and a remote controlling device that controls the remote controlled apparatus and redirecting a travel direction of the remote controlled apparatus if the signal quality level falls below a predetermined threshold. The method can further include the step of redirecting the remote controlled apparatus toward the remote controlling device or safely stopping the remote controlled apparatus or causing the remote controlled apparatus to meander so long as the signal quality level stays above the predetermined threshold.

In a fourth embodiment of the present invention, a remote controlled apparatus can include a wireless transceiver for being controlled by a remote controlling device having a wireless transceiver and a processor operatively coupled to the wireless transceiver of the remote controlled apparatus. The processor can be programmed to measure a signal quality level of signals transmitted between the wireless transceiver of the remote controlling device and the wireless transceiver of the remote controlled apparatus and redirect the remote controlled apparatus if the signal quality level falls below the predetermined threshold.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a remote controlled system that monitors signal quality in accordance with an embodiment of the present invention.

FIG. 2 is an illustration of the remote controlled system of FIG. 1, with a remote controlled apparatus beyond a signal strength threshold in accordance with an embodiment of the present invention.

FIG. 3 is an illustration of the remote controlled system of FIG. 1, with the remote controlled apparatus beyond coverage range in accordance with an embodiment of the present invention.

FIG. 4 is a flow chart illustrating a method of controlling a remote controlled apparatus in accordance with an embodiment of the present invention.

FIG. 5 is a flow chart illustrating another method of controlling a remote controlled apparatus in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

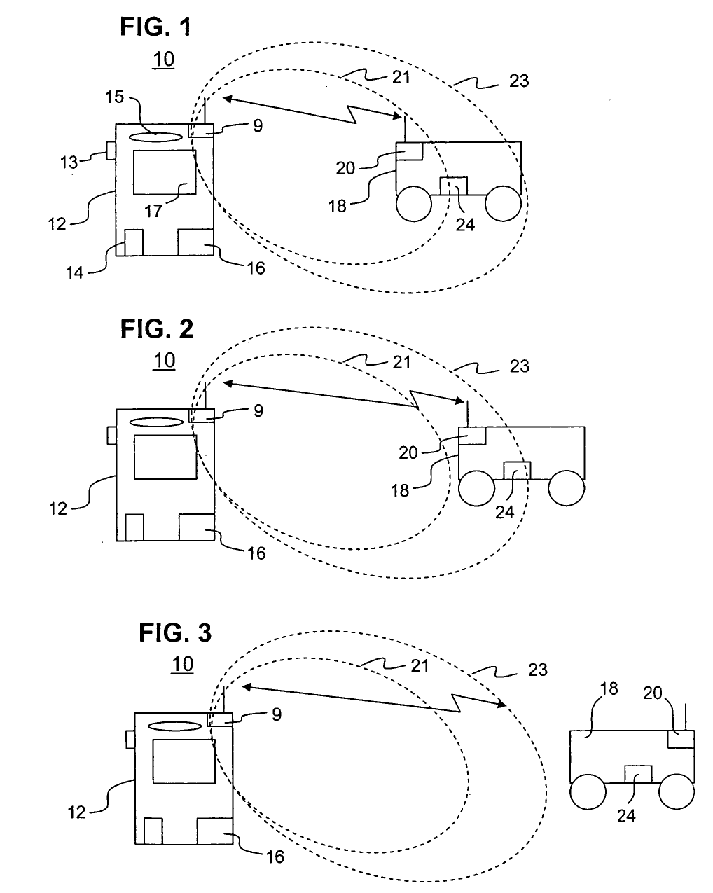

Referring to FIG. 1, a system 10 is illustrated that controls a remote controlled apparatus 18. The system 10 can include the remote controlled apparatus 18 and a remote controlling device 12. The remote controlling device 12 can include a wireless transceiver 9 for controlling the remote controlled apparatus 18 and a programmable memory or processor 16 coupled to the wireless transceiver 9. The remote controlled apparatus 18 can be an RC toy such as a car, boat, aircraft, or robot and the remote controlling device 12 can be a wireless device such as a cellular phone although other wireless devices such as two-way radios, satellite phones, wireless laptops, smart phones and R/C toy Controllers are certainly contemplated herein and within the scope of the claims.

In one embodiment, the remote controlling device 12 can be a cellular phone including the transceiver 9. The remote controlling device 12 can further include additional components such as the programmable memory or processor 16, a display 17, a vibrating device 14, a speaker 15, and a push-to-talk (PTT) button 13. The device 12 can also include other components such as microphones, cameras, keypads and other accessories (not shown) that are typically found with cellular phones. The remote controlled apparatus 18 as illustrated in FIGS. 1-3 can include a transceiver 20 and programmable memory or processor 24.

In one arrangement, the remote controlling device can include the wireless transceiver 9 for controlling the remote controlled apparatus 18 where the transceiver 9 in combination with processor 16 measures signal quality. The remote controlled apparatus 18 can include a wireless transceiver 20 coupled to a programmable memory or processor 24. The wireless transceivers (9 and 20) in the remote controlling device 12 and in the remote controlled apparatus 18 respectively can use the IEEE 802.15.4 Standard for communication or any other suitable wireless protocol or standard. Note, the processor 16 can be an 8 bit microcontroller or other suitable processor or controller and can be programmed to measure a signal quality level of signals transmitted by the wireless transceiver 20 of the remote controlled apparatus 18 and to transmit control signals to redirect the remote controlled apparatus 20 if the signal quality level falls below a predetermined threshold. Signal quality measurements can be performed in a number of ways including measuring radio signal strength indicator (RSSI) measurements or bit error rate among other signal quality measurements. The predetermined threshold can also be programmable by the user. The remote controlling device 12 can also include a user alert that warns a user when the signal quality level falls below the predetermined threshold. The user alert can come in different forms such as a visual alert on the display 17 or using an LED or other light source (not shown), an audible alert using speaker 15, or a tactile or sensory alert using vibration device 14.

Referring again to FIG. 1, the remote controlled apparatus 18 is within a range 21 corresponding to the predetermined threshold. The remote controlled apparatus 18 is outside the range 21, but still within the communication range 23 of the transceivers 9 and 20 in FIG. 2. The remote controlled apparatus 18 is illustrated as being outside of the communication range 23 in FIG. 3. The processor 16 can be programmed to transmit control signals to redirect the remote controlled apparatus 18 toward the remote controlling device 12 or to safely stop the remote controlled apparatus 18 or to cause the remote controlled apparatus 18 to meander so long as the signal quality level stays above the predetermined threshold. In another aspect, the wireless transceiver 20 in the remote controlled apparatus can also measure a signal quality level and can transmit a warning signal to the remote controlling device 12 when the signal quality level measured at the remote controlled apparatus 18 falls below a predetermined threshold.

In another aspect of the present invention, the system 10 can include a first wireless transceiver 9 in the remote controlling device 12, a second wireless transceiver 20 in the remote controlled apparatus 18, and a processor 24 coupled to the second wireless transceiver of the remote controlling device. The processor 24 can be programmed to measure a signal quality level of signals transmitted by the first wireless transceiver 9 and to redirect the remote controlled apparatus 18 if the signal quality level falls below a predetermined threshold. Note, the remote controlled apparatus 18 can redirect itself and operate in an autonomous mode in this instance until a proper signal quality is measured. Note, the predetermined threshold used by the remote controlled apparatus 18 or used by the remote controlling device 12 can typically be the same, but do not necessarily need to be the same.

The processor 16 coupled to the first wireless transceiver 9 or the processor 24 coupled to the second wireless transceiver 20 can be programmed to measure signal quality in the form of received signal strength indicator measurements or bit error rate for example. The processor 24 in the remote controlled apparatus 18 or a processor 16 in the remote controlling device 12 can further be programmed to redirect the remote controlled apparatus toward the remote controlling device or to safely stop the remote controlled apparatus or to cause the remote controlled apparatus to meander so long as the signal quality level stays above the predetermined threshold.

In a more specific embodiment, a radio-controlled toy can use the IEEE standard 802.15.4, a two-way, short-range radio to control the movement of the toy. RSSI (received signal strength indicator) measurements can be used to detect when the toy is reaching a distance threshold (close to being out of range of the user). Software residing in both the toy and the controlling device can have a preset (default) “out of range” set point. The user can also change this setting to fit whatever environment conditions exist.

The systems described above can have two modes of operation such as a manual control mode and an autopilot mode. In manual mode, the user can be alerted when the vehicle is at a pre-defined percentage of range (for example, 75%). With this mode, the user would make corrections to the remote vehicle manually to protect the vehicle from being lost. In autopilot mode, if the user does not change course and the vehicle continues to move further out of range, (for example, now 90% of the range), the toy can automatically enter the autonomous mode to prevent loss or damage. Depending on the user's preference, the toy can be programmed to stop (particularly for ground or water based vehicles) or change direction to bring the toy back to the user by changing its heading (say 180 degrees) until it is in acceptable range or the toy can start a meandering algorithm to keep the toy within range of the controlling transceiver.

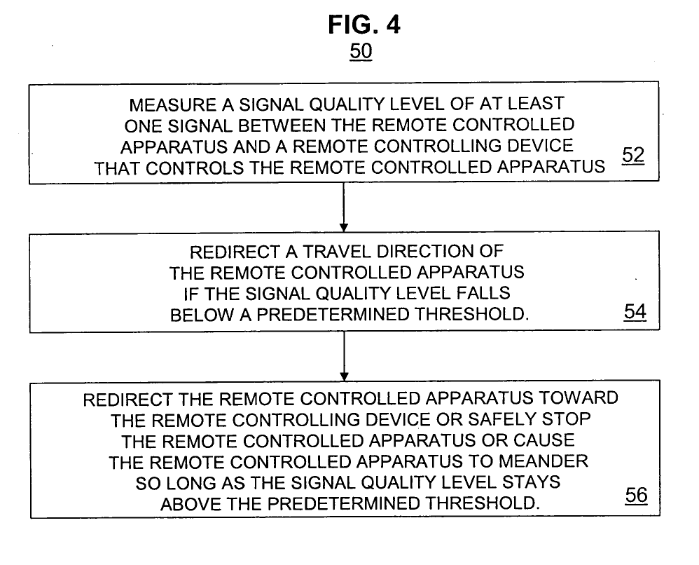

Referring to FIG. 4, a method 50 of controlling a remote controlled apparatus can include the step 52 of measuring a signal quality level of at least one signal between the remote controlled apparatus and a remote controlling device that controls the remote controlled apparatus and redirecting a travel direction of the remote controlled apparatus if the signal quality level falls below a predetermined threshold at step 54. The method 50 can further include the step 56 of redirecting the remote controlled apparatus toward the remote controlling device or safely stopping the remote controlled apparatus or causing the remote controlled apparatus to meander so long as the signal quality level stays above the predetermined threshold.

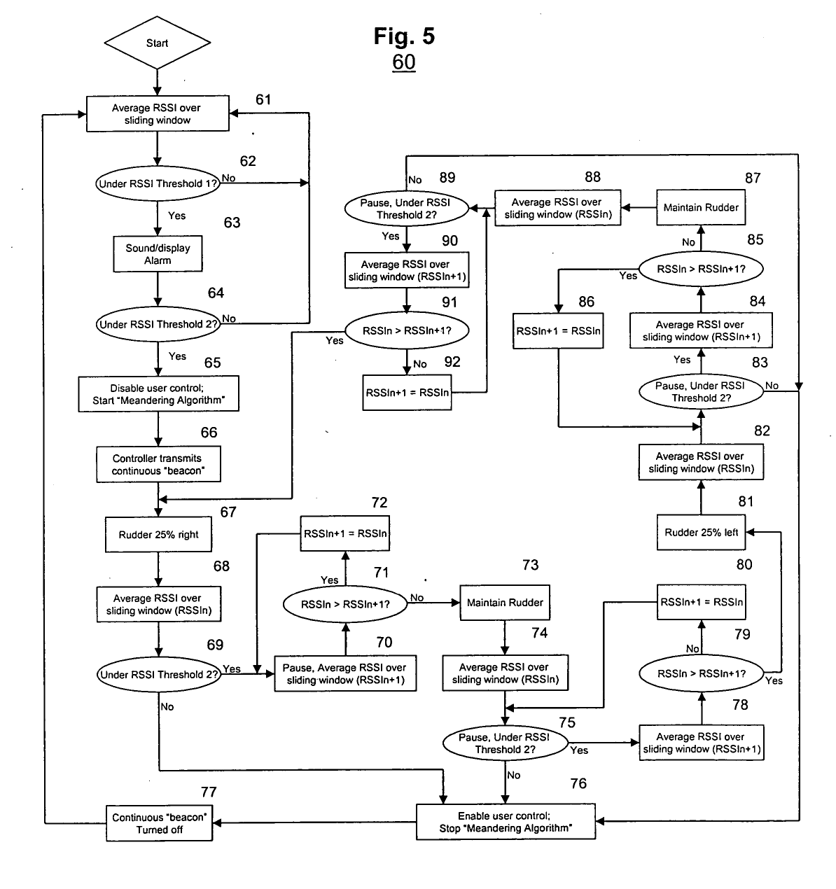

In a more specific embodiment, a method 60 as shown in FIG. 5 can include the steps of measuring and averaging RSSI over a sliding window at step 61. If the average RSSI falls below a first threshold at step 62, the method returns to step 61 and otherwise issues an alert at step 63 indicative that the remote controlled apparatus is heading towards a range with weaker signal strength or reception. If the average RSSI falls below a second (lower) threshold at step 64, then the user control is disabled and a “meandering algorithm” is initiated at step 65. A beacon can be transmitted by the controller at step 66. If the average RSSI remains above the second threshold at step 64, then the method returns to step 61.

In an attempt to return to a range where there is a stronger signal strength, the remote controlled device can be made to turn in one direction, for example by turning a rudder right for about 25% at step 67. RSSI can be averaged over a sliding window RSSIn at step 68. A determination is made as to whether the RSSI falls below the second threshold at step 69. If the RSSI measurement exceeds the threshold (a stronger RSSI is indicated), then the user control is enabled and the meandering algorithm is stopped at step 76 and the continuous beacon is turned off at step 77 with the method returning to step 61. If, however, the RSSI measurement falls below the second threshold (a weaker RSSI is indicated), then after a pause, a new average RSSI over a sliding window (RSSIn+1) is measured at step 70 and compared to a prior average RSSI measurement (RSSIn). If the new RSSI measurement is weaker (or the old measurement is stronger) at step 71, then the method proceeds to step 72 where the latest average RSSI replaces the prior average RSSI measurement (i.e., set RSSIn=RSSIn+1). The method then returns to step 70 where, after a pause, the RSSI (RSSIn) is again compared to a newly-calculated RSSI (RSSIn+1). Steps 70-27 are repeated as long as each newly-calculated RSSI is less than a previous RSSI (i.e., RSSIn+1<RSSIn).

If the new RSSI measurement is stronger (or the old measurement is weaker) at step 71, then the rudder is maintained at step 73. Once again, another RSSI measurement over a sliding window (RSSIn) can be made at step 74. If the RSSI measurement is stronger than the second threshold at step 75, then the method stops the meandering algorithm at step 76, turns off the beacon at step 77 and returns to step 61. If the RSSI measurement is weaker than the second threshold, the Average RSSI is measured once again over a sliding window (RSSIn+1) at step 78 and compared to a prior measurement (RSSIn) at step 79. If a stronger signal is measured at step 79, the new measurement (RSSIn+1) will be set to the “old measurement” (RSSIn) at step 80. The method repeats steps 75 through 80 until either the RSSI increases to above the second threshold, in which case the method breaks the loop at step 75 and proceeds to step 76, or a new RSSI measurement (RSSIn+1) is less than an immediately prior RSSI measurement (RSSIn), in which case the method breaks the loop at step 79 and proceeds to step 81.

Once again, in an attempt to return to a range where there is a stronger signal strength, the remote controlled device can be made to turn in another direction, for example, by turning a rudder left for about 25% at step 81 if the new RSSI measurement (RSSIn+1) is weaker than the old RSSI measurement (RSSIn) at step 79. RSSI can be averaged over a sliding window RSSIn at step 82 and a determination is made once again after a pause if the RSSI falls below the second threshold at step 83. If the RSSI measurement exceeds the threshold (a stronger RSSI is indicated), then the user control is enabled and the meandering algorithm is stopped at step 76 and the continuous beacon is turned off at step 77 and the method returns to step 61.

If the RSSI measurement falls below the second threshold (a weaker RSSI is indicated) at step 83, then a new average RSSI over a sliding window (RSSIn+1) is measured at step 84 and compared to a prior average RSSI measurement (RSSIn) at step 85. If the new RSSI measurement is weaker at step 85, then the method proceeds to step 86 where again the latest average RSSI replaces the prior average RSSI measurement (i.e., set RSSIn=RSSIn+1). The method then returns to step 83 where, after a pause, the RSSI (RSSIn) is compared to the second threshold. If the average RSSI at this point is still less than the second threshold, a new average RSSI is again calculated at step 84 and the newly-calculated RSSI (RSSIn+1) is compared to the previous average RSSI (RSSIn) at step 85.

Steps 83-86 repeat until the loop is broken either at step 83, when the RSSI increases above the second threshold, or at step 85 when a newly-calculated average RSSI (RSSIn+1) exceeds the previous RSSI (RSSIn). If at step 83, the average RSSI exceeds the second threshold, then as previously described user control is enabled and the meandering algorithm is stopped at step 76 and the continuous beacon is turned off at step 77 and the method returns to step 61.

If a newly-calculated RSSI (RSSIn+1) is greater than the previous RSSI (RSSIn) at step 85, then the method proceeds to step 87 at which the rudder position is maintained, and a new average of the RSSI is computed over a sliding window at step 88. At step 89, after a pause, the method ascertains whether the new average RSSI is greater than the second threshold. If it is, then user control is enabled and the meandering algorithm is. stopped at step 76 and the continuous beacon is turned off at step 77 and the method returns to step 61. Otherwise, if at step 89, the average RSSI measurement is less than the second threshold, then a new average RSSI (RSSIn+1) is calculated at step 90 and compared at step 91 to the prior average RSSI (RSSIn). If the prior average RSSI (RSSIn) is greater than the new average, then the method proceeds to step 92 where the latest average RSSI replaces the prior average RSSI (i.e., set RSSIn=RSSIn+1). The method then returns to step 89.

Steps 89-92 repeat unless either, at step 89, the latest average RSSI exceeds the second threshold, or, at step 91, the latest average RSSI (RSSIn+1) is weaker than the prior average RSSI (RSSIn). If at step 89 the latest average RSSI exceeds the second threshold, then the method returns to step 76 and the method proceeds through step 77 to step 61 as already described. If at step 91, the most recently calculated average RSSI measurement (RSSIn+1) is weaker than the prior average RSSI measurement (RSSIn), the method returns to step 67. From step 67, the method repeats in the manner already described.

Note this is merely an example of one algorithm that can be used to redirect an remote controlled apparatus approaching a range with weaker signal strength or a weaker signal quality measurement toward a range with a stronger signal quality.

Currently there are no means for a user to know that the toy R/C vehicle is nearing the end of its range. Typically, the toy stops operating when the range is exceeded. Embodiments herein use signal quality measurements such as RSSI measurements and two-way communication to measure range, optionally alert the user, and take action to prevent the toy from exceeding the range of control or have the vehicle change its heading and return to the user.

In light of the foregoing description, it should be recognized that embodiments in accordance with the present invention can be realized in hardware, software, or a combination of hardware and software. A system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A remote controlling device, comprising:
a wireless transceiver for controlling a remote controlled apparatus having a wireless transceiver; and
a processor coupled to the wireless transceiver of the remote controlling device, wherein the processor is programmed to:
measure a signal quality level of signals transmitted by the wireless transceiver of the remote controlled apparatus; and
alerting a user when the signal quality level falls below a predetermined threshold.

2. The remote controlling device of claim 1, wherein the wireless transceiver in the remote controlling device and in the remote controlled apparatus use the IEEE 802.15.4 Standard.

3. The remote controlling device of claim 1, wherein the processor is programmed to measure received signal strength indicator measurements or bit error rate.

4. The remote controlling device of claim 1, wherein the predetermined threshold is a programmable setting.

5. The remote controlling device of claim 1, wherein the remote controlling device is further programmed to transmit control signals to redirect the remote controlled apparatus if the signal quality level falls below the predetermined threshold.

6. The remote controlling device of claim 5, wherein the processor is further programmed to transmit control signals to redirect the remote controlled apparatus toward the remote controlling device or to safely stop the remote controlled apparatus or to cause the remote controlled apparatus to meander so long as the signal quality level stays above the predetermined threshold.

7. The remote controlling device of claim 1, wherein the wireless transceiver in the remote controlled apparatus also measures a signal quality level and transmits a warning signal to the remote controlling device when the signal quality level measured at the remote controlled apparatus falls below a predetermined threshold.

8. The remote controlling device of claim 1, wherein the remote controlling device comprises a two-way radio, a cellular phone, a cordless home phone, a compute with wireless capability, a radio controlled toy controller, or a smart phone.

9. The remote controlling device of claim 1, wherein the remote controlled device comprises a remote controlled car, boat, aircraft, or robot.

10. A system for controlling a remote controlled apparatus, comprising:
a first wireless transceiver in a remote controlling device for controlling the remote controlled apparatus;
a second wireless transceiver in the remote controlled apparatus; and
a processor coupled to the second wireless transceiver of the remote controlling device, wherein the processor is programmed to:
measure a signal quality level of signals transmitted by the first wireless transceiver;
redirect the remote controlled apparatus if the signal quality level falls below a predetermined threshold.

11. The system of claim 10, wherein the remote controlled apparatus is a remote controlled car, a remote controlled boat, or a remote controlled aircraft and the remote controlling device comprises a two-way radio, a cellular phone, a cordless home phone, a computer with wireless capability, a radio controlled toy controller, or a smart phone.

12. The system of claim 10, wherein the first and second wireless transceivers use the IEEE 802.15.4 Standard.

13. The system of claim 10, wherein the system further comprises a processor coupled to the first wireless transceiver, wherein the processor coupled to the first wireless transceiver is programmed to measure a signal quality level of signals transmitted by the second wireless transceiver and to transmit signals to redirect the remote controlled apparatus when a signal quality level of the signals transmitted by the second wireless transceiver falls below a predetermined threshold.

14. The system of claim 13, wherein the processor coupled to the first wireless transceiver or the processor coupled to the second wireless transceiver is programmed to measure received signal strength indicator measurements or bit error rate.

15. The system of claim 10, wherein the predetermined threshold is a programmable setting.

16. The system of claim 10, wherein the remote controlling device further comprises a user alert that warns a user when the signal quality level falls below the predetermined threshold.

17. The system of claim 10, wherein the processor in the remote controlled apparatus or a processor in the remote controlling device is further programmed to redirect the remote controlled apparatus toward the remote controlling device or to safely stop the remote controlled apparatus or to cause the remote controlled apparatus to meander so long as the signal quality level stays above the predetermined threshold.

18. The system of claim 10, wherein the second wireless transceiver transmits a warning signal to the remote controlling device when the signal quality level measured at the remote controlled apparatus falls below a predetermined threshold.

19. A method of controlling a remote controlled apparatus, comprising the steps of:
measuring a signal quality level of at least one signal between the remote controlled apparatus and a remote controlling device that controls the remote controlled apparatus;
redirecting a travel direction of the remote controlled apparatus if the signal quality level falls below a predetermined threshold.

20. The method of claim 19, wherein the method further comprises the step of redirecting the remote controlled apparatus toward the remote controlling device or safely stopping the remote controlled apparatus or causing the remote controlled apparatus to meander so long as the signal quality level stays above the predetermined threshold.

21. A remote controlled apparatus, comprising:
a wireless transceiver for being controlled by a remote controlling device having a wireless transceiver; and
a processor operatively coupled to the wireless transceiver of the remote controlled apparatus, wherein the processor is programmed to:
measure a signal quality level of signals transmitted between the wireless transceiver of the remote controlling device and the wireless transceiver of the remote controlled apparatus; and
redirect the remote controlled apparatus if the signal quality level falls below the predetermined threshold.

22. The remote controlled apparatus of claim 21, wherein the processor is further programmed to receive control signals over the air from the remote controlling device to redirect the remote controlled apparatus toward the remote controlling device or to safely stop the remote controlled apparatus or to cause the remote controlled apparatus to meander so long as the signal quality level stays above the predetermined threshold.

23. The remote controlled apparatus of claim 21, wherein the processor is further programmed to redirect the remote controlled apparatus itself if the remote controlled apparatus measures a signal quality below the predetermined threshold.

24. The remote controlled apparatus of claim 21, wherein the processor is further programmed to alert a user when the signal quality level falls below a predetermined threshold.
